(19) United States
(12) Patent Application Publication
(10) Pub. No.: US 2002/0177467 A1
(43) Pub. Date: Nov. 28, 2002

(54) Wireless communication apparatus with lighting function

(76) Inventor: Chien Kuo Hsu, San Chong City (TW)

Correspondence Address: BACON & THOMAS, PLLC, 625 SLATERS LANE, FOURTH FLOOR, ALEXANDRIA, VA, 22314

(21) Appl. No.: 09/863,374

(22) Filed: May 24, 2001

(51) Int. Cl. H04M 1/00

(52) U.S. Cl. 455/556; 455/66; 455/550

(57) ABSTRACT

A wireless communication apparatus, such as a mobile phone, is provided on a handset with a light-emitting element and a switch electrically connecting the light-emitting element to positive and negative terminals of a battery of the communication apparatus. The light-emitting element and the switch may be provided at a front portion or a back cover of the handset. By pushing the switch, power is supplied from the battery to the light-emitting element for the latter to emit light beams, allowing the communication apparatus to serve as a lighting tool or a pointer. The light-emitting element may be a bulb, a light emitting diode, a laser beam emitter or other suitable device.

### BACKGROUND OF THE INVENTION

The present invention relates to a wireless communication apparatus with lighting function, and more particularly to a lighting structure that enables a wireless communication apparatus, such as a mobile phone, to also function like a lighting tool or a pointer.

With the quick and prosperous developments in communication technologies and the continuously upgraded living standards in the modern society, a mobile phone has become a very popular communication product among most consumers. Generally, a mobile phone includes a handset and a battery case detachably connected to the handset for supplying power needed by the handset to function normally. In a conventional battery case, only a charging battery is provided. That is, the mobile phone powered by the conventional battery functions only as an ordinary communication tool. In view that the mobile phone has become so popular among consumers and is often carried along with the consumers, it would be more useful and valuable if it is provided with additional functions, for example, emitting light during a power failure.

### SUMMARY OF THE INVENTION

It is therefore a primary object of the present invention to provide a wireless communication apparatus with lighting function, so that the wireless communication apparatus could also be used as a lighting tool or a pointer.

In a first embodiment of the present invention, the wireless communication apparatus includes a light-emitting element and a switch provided in a front portion of a handset thereof. By pushing the switch, current is supplied from a battery of the apparatus to the light-emitting element for the same to emit light beams.

In second embodiment of the present invention, the wireless communication apparatus includes a light-emitting element and a switch provided on a circuit board attached to a back cover of a handset of the apparatus. The switch could be actuated by pushing a push-button plate provided on the back cover to press against the switch, so that current is supplied from a battery of the apparatus to the light-emitting element for the same to emit light beams that project from a window correspondingly provided on the back cover of the handset.

### BRIEF DESCRIPTION OF THE DRAWINGS

The structure and the technical function adopted by the present invention to achieve the above and other objects can be best understood by referring to the following detailed description of the preferred embodiments and the accompanying drawings, wherein

FIG. 1 is an assembled perspective view of a mobile phone with lighting function according to a first embodiment of the present invention;

FIG. 2 is an exploded perspective view of FIG. 1;

FIG. 3 is an exploded perspective view showing a switch and a light-emitting element in the mobile phone of FIG. 1;

FIG. 4 is an exploded perspective view of a mobile phone with lighting function according to a second embodiment of the present invention; and

FIG. 5 is an assembled perspective view of the mobile phone of FIG. 4.

### DETAILED DESCRIPTION OF THE PREFERRED EMBODIMENTS

The present invention relates to a wireless communication apparatus with lighting function. In the following description with reference to the attached drawings, a mobile phone is illustrated and described only as a preferred embodiment of the present invention.

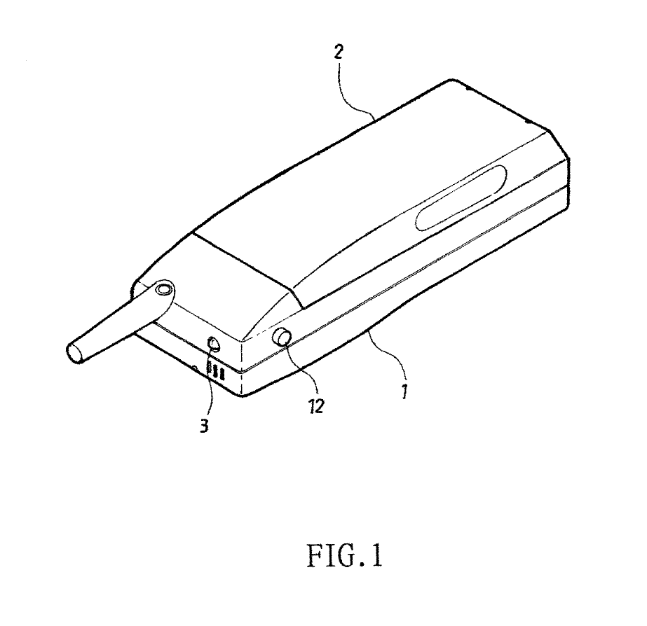

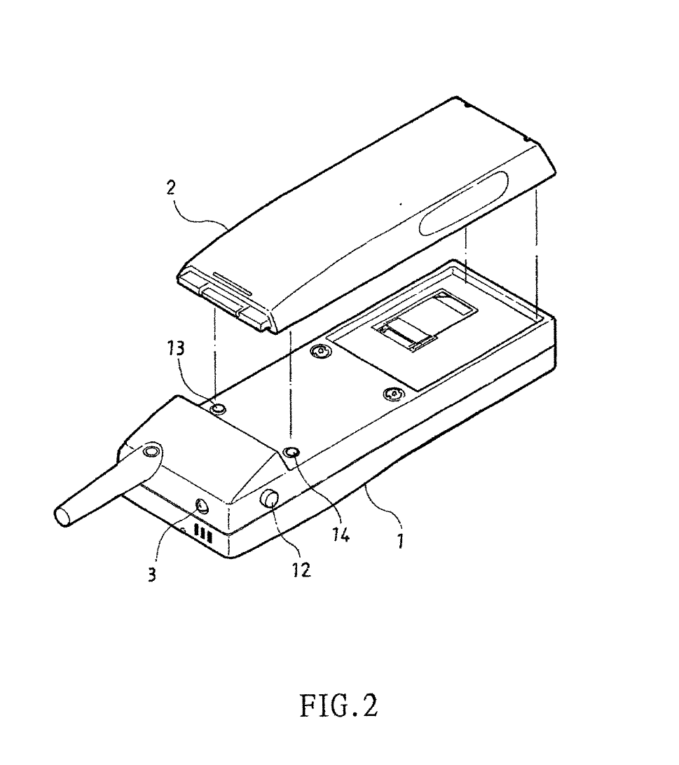

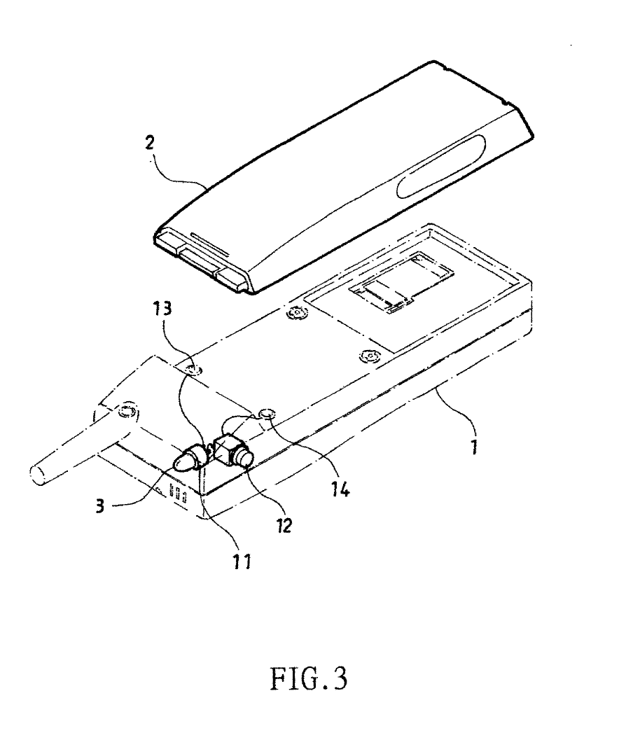

Please refer to FIGS. 1, 2 and 3 in which a mobile phone 1 with lighting function according to a first embodiment of the present invention is shown. The mobile phone 1 is provided in a front portion of a handset with a fixing base 11 for a light-emitting element 3 to plug thereinto, and at one side with a switch 12. The fixing base 11 provides two pins, one of which is electrically connected to one of two contacts of the switch 12 while the other pin is electrically connected to a positive power input terminal 13 of the mobile phone 1. The other contact of the switch 12 is electrically connected to a negative power input terminal 14 of the mobile phone 1. Whereby, when a battery 2 is connected to the mobile phone 1, current is supplied from the battery 2 to the mobile phone 1 via the power input terminals 13, 14 not only to power the mobile phone 1 for it to function normally as a communication apparatus, but also to power the light-emitting element 3 via the switch 12. That is, when the switch 12 is pushed, power from the battery 2 is supplied to the fixing base 11 and accordingly the light-emitting element 3 plugged into the fixing base 11, allowing the light-emitting element 3 to emit light beams. The light-emitting element 3 may be a bulb, a light emitting diode or a laser beam emitter. The light beams emitted from the light-emitting element 3 allow the mobile phone 1 to serve as a lighting tool in a dark environment or as a pointer for indicating purpose, making the mobile phone 1 more practical for use.

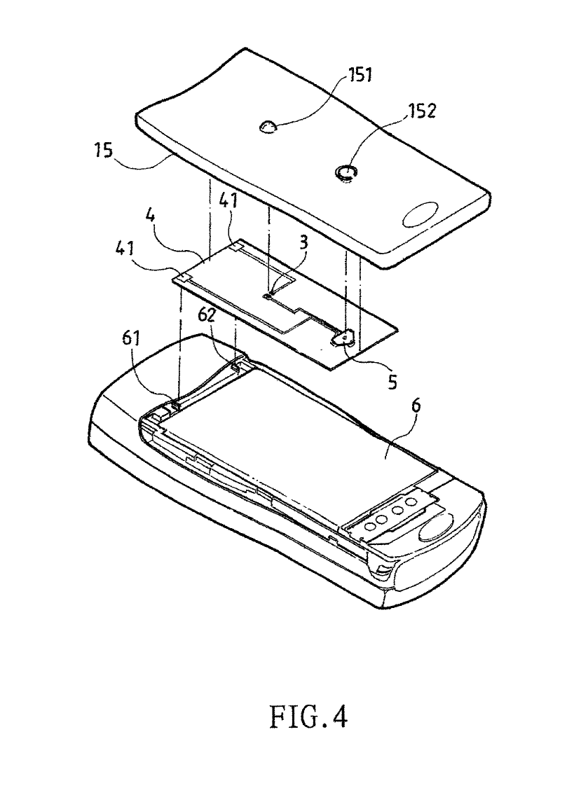

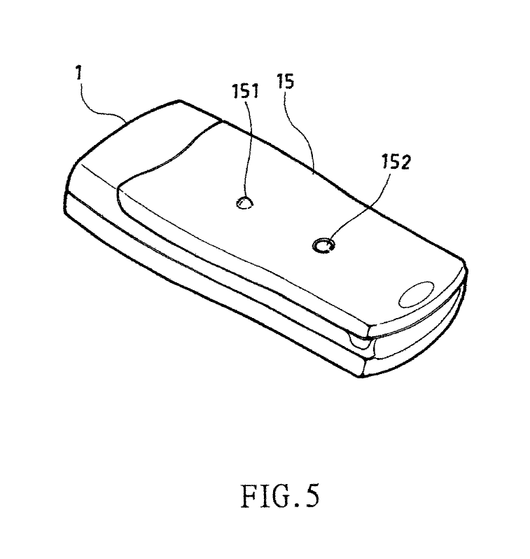

FIGS. 4 and 5 shows a mobile phone according to a second embodiment of the present invention. In this second embodiment, the mobile phone includes handset 1 having a back cover 15, and a battery 6 mounted in the handset 1 and covered by the back cover 15. A light-emitting element 3 is welded to a soft circuit board 4 in a suitable manner, and a sheet-type switch 5 is provided on the circuit board 4. The light-emitting element 3 is electrically connected to the switch 5 and to two contacts 41 provided at a front portion of the circuit board 4. The circuit board 4 is fitly attached to an inner surface of the back cover 15, and the back cover 15 is provided at positions corresponding to the light-emitting element 3 and the switch 5 with a window 151 in the form of a through hole and a push-button plate 152, respectively. When the back cover 15 is properly covered to the back of the handset, the two contacts 41 on the circuit board 4 would separately contact with positive and negative terminals 61, 62 of the battery 6, so that current could be supplied from the battery 6 to the circuit board 4. By pushing the push-button plate 152 on the back cover 15 to press against the switch 5 on the circuit board 4, the light-emitting element 3 is made to emit light beams, allowing the handset of the mobile phone 1 to serve as a lighting tool or a pointer.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A wireless communication apparatus with lighting function, comprising a handset and a battery detachably connected to said handset, said handset being provided in a front portion with a light-emitting element, such as a bulb, a light emitting diode or a laser beam emitter, and at one side with a switch, said light-emitting element being electrically connected to positive and negative power input terminals on said handset via said switch, whereby when said battery is connected to said handset, current is supplied from said battery to said handset via said power input terminals not only to power said handset for the same to function normally as a wireless communication apparatus, but also to power said light-emitting element via said switch, and by pushing said switch, said light-emitting element is supplied with current to emit light beams, allowing said communication apparatus to serve as a lighting tool or pointer.

2. The wireless communication apparatus with lighting function as claimed in claim 1, wherein said wireless communication apparatus is a mobile phone.

3. A wireless communication apparatus with lighting function, comprising a handset, a battery removably mounted in said handset and covered by a back cover of said handset, a soft circuit board attached to an inner surface of said back cover with two contacts contacting with positive and negative terminals of said battery, a light-emitting element welded to said circuit board, and a switch provided on said circuit board to electrically connect said light-emitting element to said two contacts provided on said circuit board; said back cover being provided with a window and a push-button plate corresponding to said light-emitting element and said switch, respectively; whereby by pushing said push-button plate on said back cover to press against said switch on said circuit board attached to the inner surface of said back cover, said light-emitting element is made to emit light beams, allowing said communication apparatus to serve as a lighting tool or a pointer.

4. The wireless communication apparatus with lighting function as claimed in claim 3, wherein said wireless communication apparatus is a mobile phone.
